(19) United States
(12) Patent Application Publication
(10) Pub. No.: US 2017/0158803 A1
(43) Pub. Date: Jun. 8, 2017

(54) URETHANE ACRYLIC POLYMERS WITH UNIQUE PHYSICAL PROPERTIES

(71) Applicant: Arkema France, Colombes (FR)

(72) Inventors: Mohammad Zahidul AMIN, Yokohama-shi Kanagawa (JP); Toshiya SUGIMOTO, Yokohama-shi Kanagawa (JP); Mingxin FAN, Guangzhou (CN)

(21) Appl. No.: 15/321,348

(22) PCT Filed: Jun. 23, 2014
(86) PCT No.: PCT/JP2014/067848

§ 371 Date: Dec. 22, 2016

(51) Int. Cl. C08G 18/44; C09D 5/00; C08G 18/75; C08G 18/76; C09D 175/16; C08G 18/67

(52) U.S. Cl. CPC C08G 18/44; C09D 175/16; C08G 18/675; C08G 18/755; C08G 18/7621; C08G 18/758; C09D 5/00

(57) ABSTRACT

A polymer comprising a reaction product of the ingredients including [i] a first homopolymeric or co-polymeric polycarbonate polyol; [ii] an organic polyisocyanate; and [iii] a hydroxy-functional (meth)acrylate having the given formula; and with the proviso that when the first polycarbonate polyol is not co-polymeric, then the ingredients further includes [iv] a second homopolymeric or co-polymeric polycarbonate polyol different from the first one, and wherein the polycarbonate polyol(s) is/are linked to the polyisocyanate via a urethane linkage, and wherein the polyisocyanate is linked to the alkyl moiety of the (meth)acrylate via a urethane linkage.

### TECHNICAL FIELD

The present invention relates to a urethane acrylate oligomer or polymer including at least one of a co-polymeric polycarbonate unit and a co-reacted urethane acrylate unit. The present invention also relates to a curable composition including at least one oligomer above, to a manufacturing process for the urethane acrylate oligomer, and to a cured product made from the urethane acrylate oligomer or the curable composition.

### BACKGROUND

Various radiation curable coating polymers, such as epoxy acrylates, polyester acrylates, and urethane acrylates, have been developed in the art. Such conventional acrylate polymers are commercially available.

Acrylate polymers have advantages of having very low volatile organic compounds (VOC) as well as high productivity. Ultraviolet (UV) light and electron beam (EB) are the most typical forms of radiation which are used to generate free radicals which initiate the polymerization or cure.

Urethane acrylate polymer is one of the radiation curable coating polymers. Urethane acrylates are widely used in ultraviolet (UV) cure industries, and they represent a class of resin materials for coatings and adhesives.

Some polycarbonate-containing acrylate-containing polymers having a single kind of homopolycarbonate moiety have been proposed in the art.

Patent Document 1 (Yamamoto et al., U.S. Pat. No. 5,178,952A) discloses a radiation curable resin which is a reaction product of a polyester polyol and/or polycarbonate polyol, a diisocyanate, and a polyfunctional (meth)acrylate containing a hydroxyl group therein. Only one homopolycarbonate polyol is used in the conventional process of Document 1.

Patent Document 2 (Fan et al., U.S. Pat. No. 6,451,958B1) discloses a radiation curable acrylate-terminated polymer having a single kind of homopolycarbonate moiety that aims to improve adhesion and impact strength properties.

Patent Document 3 (Tanaka et al., JP2001323042 A) discloses a segmented polyurethane made from (A) a polycarbonate diol prepared from an aliphatic hydrocarbon diol containing 1,12-dodecane diol and a carbonate compound, (B) a chain expander, and (C) a diisocyanate. The conventional polyurethane includes a sole kind of homopolycarbonate diol.

Patent Document 4 (Tanaka et al., JP5347958132) discloses a photo-curable composition prepared by a transesterification of a sole polycarbonate diol, one or more (meth)acrylate ester(s), and a silane compound. The conventional composition is characterized in including cage-like silsesquioxane component to have sufficient surface hardness. The prior documents above are incorporated by reference in the present disclosure.

### CITATION LIST

### Patent Literature

[Patent Document 1] U.S. Pat. No. 5,178,952

[Patent Document 2] U.S. Pat. No. 6,451,958

[Patent Document 3] Japanese laid-open Pub. No 2001-323042

[Patent Document 4] Japanese Pat. No. 5347958

### SUMMARY OF INVENTION

### Technical Problem

The conventional urethane acrylates oligomers or polymers have certain drawbacks. Urethane acrylates typically have a limited viscosity and low molecular weight, which result in good hardness, but lack flexibility or toughness. It has been very difficult and contradictory to give urethane acrylates both enough hardness and elongation.

The conventional urethane acrylates are also silent on any self healing properties when cured.

None of the prior art provides balanced properties of elongation and abrasion resistance along with good self healing properties.

### Solution to Problem

The present inventors have designed and developed a novel curable polymer which have excellent elongation and abrasion resistance to complete the present invention.

In an embodiment, the present invention provides a urethane-acrylated curable polymer, comprising a reaction product of the ingredients including:

[i] a first homopolymeric or co-polymeric polycarbonate polyol; and

[ii] an organic diisocyanate; and

[iii] a hydroxy-functional acrylate or methacrylate of general formula

(Acr)_{y}-(A)-OH

where Acr is an acrylate or methacrylate group, A is the residue of a polyol A(OH)_{y+1} with y being an integer ranging from 1 to 5, preferably A is selected from C₂ to C₁₈ alkyl and C₂ to C₁₈ alkyl that may be modified by at least one unit of a cyclic ester in particular caprolactone or A is C₂ to C₁₈ alkoxylated alkyl, with alkoxy being in C₂ to C₄, and preferably the acrylate or methacrylate having a functionality in acrylate or methacrylate groups ranging from 1 to 5,
and with the proviso that when the first polycarbonate polyol is not co-polymeric, then the ingredients further includes:

[iv] a second homopolymeric or co-polymeric polycarbonate polyol, and

wherein the polycarbonate polyol(s) is/are linked to the diisocyanate via a urethane linkage, and

wherein the diisocyanate is linked to the alkyl moiety of the hydroxy-functional acrylate or methacrylate via a urethane linkage.

In another embodiment, the present invention provides a curable composition including the polymer above. The present invention may also provide a cured product prepared by curing the polymer above, or an article comprising a substrate coated by the cured product.

In still another embodiment, the present invention provides a process for preparing the curable polymer above, comprising the steps of:

a) reacting one of a) reacting one of said hydroxy-functional acrylate or methacrylate according to iii) and the said polycarbonate polyol according to i) with a molar excess of said isocyanate according to ii) by progressive addition of said hydroxy-functional acrylate or methacrylate according to iii) or the polycarbonate polyol i) in said isocyanate ii), in the presence of an urethane reaction catalyst and of a polymerization inhibitor, to form an isocyanate adduct; and then

b) reacting the resultant isocyanate adduct of step a) with the other of iii) and i) by progressive addition of the other of iii) of i) into said adduct to the resulting reactive mixture to obtain the said polymer. In one aspect of the embodiment, if the second polycarbonate polyol according to iv) is used, the progressive addition of the first polycarbonate polyol according to i) may be followed by a successive step with said polycarbonate polyol according to iv) by progressive addition of iv). In one aspect, both reaction steps a) and b) may be in bulk and in the absence of any solvent.

### Advantageous Effects of Invention

The novel curable polymer has well-balanced physical properties between excellent elongation and good abrasion resistance and tensile strength. The balanced properties are superior to the conventional product in the art. The present polymer may be cured by a radiation. The cured product can provide excellent self healing properties.

### BRIEF DESCRIPTION OF DRAWINGS

FIG. 1 illustrates a chart of gel permeation chromatography (GPC) obtained from the present polymer according to Example 2. The chart includes three curves that correspond to synthetic steps in the protocol of the Example.

FIG. 2 illustrates a GPC chart obtained from the present polymer according to Example 4. The chart includes three curves that correspond to synthetic steps in the protocol of the Example.

FIG. 3 illustrates a GPC chart obtained from the present polymer according to Example 5. The chart includes two curves that correspond to synthetic steps in the protocol of the Example.

FIG. 4 illustrates a GPC chart obtained from the present polymer according to Example 6. The chart includes three curves that correspond to synthetic steps in the protocol of the Example.

FIG. 5 illustrates GPC charts obtained from three conventional polymers according to comparative example 1 to 3.

FIG. 6 shows photographs representing four levels for evaluating the abrasion resistance test (written in ‘Examples’ section) to easily compare each other. The four levels are “Lot of Scratch”, “Little Scratch”, “Almost No Scratch”, and “No Scratch”; the photographs were taken from the rubbed samples according to comparative example 1, Example 3, Example 5, and Example 2, respectively. The photographs are separately shown again below in an enlarged size.

FIG. 7 shows an enlarged photograph of a coating made from the present polymer according to Example 2, which was subjected to the abrasion resistance test. The result represents Level 4, “No Scratch”.

FIG. 8 shows an enlarged photograph of a coating made from the present polymer according to Example 3, which was subjected to the abrasion resistance test. The result represents Level 2, “Little Scratch”.

FIG. 9 shows an enlarged photograph of a coating made from the present polymer according to Example 5, which was subjected to the abrasion resistance test. The result represents Level 3, “Almost No Scratch”.

FIG. 10 shows an enlarged photograph of a coating made from a comparative polymer according to comparative example 1, which was subjected to the abrasion resistance test. The result represents Level 1, “Lot of Scratch”.

FIG. 11 is a photograph to exemplify how to make scratches on a coated surface in the self-healing test. The initial condition works as the reference of the self-healing test.

FIG. 12 shows photographs representing four levels for evaluating the self-healing test (written in ‘Examples’ section) to easily compare each other. The four levels are “No Restoration”, “Little Restored”, “Almost Restored”, and “Completely Restored”; the photographs were taken from the rubbed samples according to comparative example 3, Example 5, Example 1, and Example 4, respectively. The photographs are separately shown again below in an enlarged size.

FIG. 13 is an enlarged photograph of a coating made from the present polymer according to Example 1, which was subjected to the self-healing test. The result represents Level 3, “Almost Restored”.

FIG. 14 is an enlarged photograph of a coating made from the present polymer according to Example 4, which was subjected to the self-healing test. The result represents Level 4, “Completely Restored”.

FIG. 15 is an enlarged photograph of a coating made from the present polymer according to Example 5, which was subjected to the self-healing test. The result represents Level 2, “Little Restored”.

FIG. 16 is an enlarged photograph of a coating made from a conventional polymer according to comparative example 3, which was subjected to the self-healing test. The result represents Level 1, “No Restoration”.

### DESCRIPTION OF EMBODIMENTS

Polycarbonate Polyols

In the present specification, the term “polycarbonate polyol” or “PC polyol” means a polycarbonate (PC) polyol having an aliphatic or cycloaliphatic or aromatic hydrocarbyl chain. The chain may be alkyl group, such as C₁ to C₁₈ alkyl, preferably C₂ to C₁₈ alkyl, more preferably C₂ to C₁₂ alkyl, still more preferably C₂ to C₆ alkyl; cycloaliphatic group such as C₆ to C₁₈ cycloaliphatic group which may be substituted on the aliphatic chain, preferably C₆ to C₁₂ cycloaliphatic group; aromatic group such as C₆ to C₁₈ aromatic group. In an embodiment of the present invention, the PC polyol may be modified with a cyclic ester such as lactide, glycolide and caprolactone. In an aspect of the embodiment, diol may be preferred among the polyols.

In one aspect, the aliphatic, cycloaliphatic or aromatic polycarbonate polyol may be PC diol which may be based on ethylene glycol, propylene glycol, butanediol, pentanediol, hexanediol, heptanediol, octanediol, nonanediol, decanediol, cyclopropanediol, cyclobutanediol, cyclopentanediol, cyclohexanediol, cycloheptanediol, cyclooctanediol, cyclopropanediethanol, cyclobutanedimethanol, cyclopentanediethanol, cyclohexanediethanol, cycloheptanediethanol, cyclooctanediethanol, cyclopentanediethanol, cyclohexanediethanol, cycloheptanediethanol, cyclooctanediethanol, cyclopropanediethanol, cyclobutanediethanol, cyclopentanediethanol, cyclohexanediethanol, cycloheptanediethanol, cyclooctanediethanol, cyclopentanediethanol, cyclohexanediethanol, cycloheptanediethanol, cyclooctanediethanol, or ethoxylated bisphenol A, that may be unbranched or branched.

The term “co-polymeric polycarbonate polyol” or “co-polymeric PC polyol” means a polycarbonate (PC) polyol prepared by a copolymerization between two or more kinds of monomers such as those exemplified above. The “co-polymeric PC polyols” generally exclude homopolymeric PC polyols. In an embodiment, the present curable polymer may have a chemical structure derived from a co-polymeric PC polyol. The co-polymeric PC polyol may include, but not limited to, a poly C₂ to C₁₈ diol carbonate modified with a cyclic ester such as lactide, glycolide and caprolactone, and a co-polymerized carbonate of two or more poly C₂ to C₁₈ alkylene, cycloalkylene, or cycloalkylalkylene diol carbonate. In one preferred embodiment, the co-polymeric PC polyol may include caprolactone co-polymerized polyalkylenediol carbonate such as caprolactone co-polymerized polyhexanediol carbonate; or a co-polymerized carbonate of two polyalkyl, polycycloalkyl or polycycloalkylalkyl polyols, such as a co-polymerized carbonate of polycyclohexane dimethanol and polyhexane diol.

In an embodiment, the present polymer includes moieties derived from two or more kinds of homopolymeric (i.e., non-co-polymeric) polycarbonate polyols. In another embodiment, the present polymer includes moieties derived from one or more kinds of co-polymeric polycarbonate polyol(s) and optionally one or more kinds of homopolymeric polycarbonate polyol(s).

The homopolymeric or co-polymeric polycarbonate polyols may have the number average molecular weight (Mn) of 500 to 3,000, preferably 500 to 2,000, and more preferably 500 to 1,000. The number average molecular weight is calculated from OH value determined by KOH titration.

In an embodiment, the present polymer may have formula (I)

(Acr)_{y}(A)(Q)(PC)[(Q)(PC)])ₓ(Q)(A)(Acr)_{y} (I)

in which PC is the residue of the polycarbonate diol above.

In an embodiment, the polycarbonate diol above may have the formula (II)

HO(ROCOO)ₙROH (II)

In formula (II), R may be independently selected from C₁ to C₁₈ alkylene, C₆ to C₁₈ cycloalkylene which may be substituted on the alkylene chain above, and C₆ to C₁₈ aromatic groups. In one aspect, the alkylene may be C₂ to C₁₂ alkylene, preferably C₂ to C₈ alkylene. In one aspect, the cycloalkylene may be C₆ to C₁₂ cycloalkylene.

In an aspect, R may be an alkylene selected from hexamethylene, pentylene, cyclohexylene, ethylene, propylene, butylene, and cyclohexanedimethylene, or be an aromatic moiety such as ethoxylated bisphenol A.

In formula (II), n may be an integer from 1 to 100,000, preferably 1 to 10,000.

Urethane Structures

Urethane compounds have a skeleton having a urethane linkage, such as —NH—C(O)O—. In the present specification, the term “co-reacted urethane” or “co-reacted urethane acrylate (UA)” means a urethane or urethane acrylate compound comprising two or more kinds of polycarbonate moieties. In an embodiment, the present curable polymer may have a chemical structure of a co-reacted urethane. In another embodiment, the present curable polymer may have a chemical structure including a co-reacted urethane moiety and the residue of a co-polymerized polycarbonate polyol.

For instance, a polymer containing moieties derived from two or more kinds of co-polymeric or homopolymeric polycarbonate polyols, the polymer may be considered as to have a “co-reacted UA” structure. The molar ratio among the two of two or more PC polyols that used for preparing a co-reacted UA may be in the range of 100:1 to 1:100, preferably 10:1 to 1:10, more preferably 2:1 to 1:2, still more preferably 1.5:1 to 1:1.5. The ratio may be determined from physical and/or chemical properties of the ingredients, e.g. viscosity, T_{g}, transparency, and hardness. In one embodiment, the ratio may be adjusted such that the overall viscosity is well-balanced, since urethane component generally has higher viscosity.

Note that the terms of “co-reacted” and “co-polymeric” basically excludes a non-substantial use of a plurality of reactants of the same class, e.g., those inevitably incorporated in a composition during a manufacturing process. In general, the phrase “co-reacted” or “co-polymeric” do not mean an embodiment in which the second or later reactant(s) are in trace amount. For instance, a “co-reacted” UA would not be prepared from a substantial amount of first PC polyol and a non-substantial or trace amount of second PC polyol.

Isocyanates

The present polymer includes a moiety derived from an isocyanate compound. In an embodiment, the present polymer may have formula (I) above, in which Q is the residue of the isocyanate. The isocyanate may connect with A and PC via a urethane linkage.

In an embodiment, the isocyanate or polyisocyanate may have 6 to 18 carbon atoms, preferably 6 to 12 carbon atoms, except for those contained in the NCO groups. The lower number of carbon atoms, C₂ to C₅, may not be preferred since low-C isocyanate compounds are generally too volatile for any practical use, and would exert toxicity.

An isocyanate or polyisocyanate used in an embodiment may be aliphatic, cycloaliphatic or aromatic with various number of isocyanate groups, preferably two or more isocyanate groups per molecule. The isocyanate compounds may include, but not limited to, isophorone diisocyanate (IPDI), toluene diisocyanate (TDI), dicyclohexylmethane 4,4′-diisocyanate (MDI), hexamethylene diisocyanate, 4,4′-methylenebis(phenylisocyanate), xylenediisocyanate, octadecyl isocyanate, 1,5-naphthylene diisocyanate, dianisidine diisocyanate, and polymethylene polyphenylisocyanates. The polyisocyanates may be dimers, trimers, and polymers in nature such as. allophanates, isocyanurates, uretdiones, biurets, of hexamethylene diisocyanate and isophorone diisocyanate.

Acrylates or Methacrylates

The present polymer may include a portion or the residue derived from a hydroxy-functional acrylate or methacrylate, such as hydroxyalkyl acrylate or hydroxyalkyl methacrylate. In an embodiment, the portion made from (meth)acrylate may be a capping or terminal group of the polymer having the formula of (Acr)_{y}(A), where Acr is an acrylate or methacrylate moiety, and A may be an alkyl moiety A having 2 to 18 carbon atoms, preferably 2 to 12 carbon atoms, more preferably 6 to 12 carbon atoms. A may also be modified by at least one unit of a cyclic ester such as caprolactone. In one aspect, A may be alkoxylated alkyl having 2 to 18 carbon atoms, in which the alkoxy moiety has 2 to 4 carbon atoms. The number of y may be an integer from 1 to 5. In other words, “A” may be represented as the residue of a polyol A(OH)_{y+1} with y being an integer ranging from 1 to 5.

Hydroxyl containing (meth)acrylic esters may be monoesters or multi-functional esters, such as pentaerythitol triacrylate, trimethyolpropane diacrylate, hydroxyethyl acrylate, hydroxypropyl acrylate, hydroxypropyl methacrylate, hydroxyethyl methacrylate, and caprolactone-modified hydroxyl functional (meth)acrylate.

The present polymer may be prepared by a condensation reaction with or without catalysts. Catalyzed reactions are preferred due to the short reaction time and less side products. The catalysts may include, but not limited to, amines and tin-based catalysts, such as dibutyltin dilaurate, 1,4-diazabicyclo[2.2.2]-octane (DABCO), 1,8-diazabicyclo-[5.4.0]-undec-7-ene (DBU), N,N-dimethylcyclohexylamine (DMCA), tetramethyltin, tetrabutyltin, tetraoctyltin, tributyltin chloride, dibutyltin dichloride, dibutyltin oxide, dibutyltin diacetate, butyltin trichloride, dioctyltin dichloride, dioctyltin oxide, dioctyltin dilaurate, dioctyltin diacetate. Other metal-based catalysts containing zinc, iron, bismuth, or zirconium may be also used.

In one aspect, the present polymer may be prepared by a process comprising the acts of reacting the hydroxyalkyl acrylate or hydroxyalkyl methacrylate above with a molar excess of isocyanate to form an isocyanate adduct; and then reacting the resultant isocyanate adduct with one or more of the co-polymeric polycarbonate polyol(s) above or two or more of non-co-polymeric polycarbonate polyols. In another aspect, the present polymer may be prepared by a process comprising the acts of reacting one or more of the co-polymeric polycarbonate polyol(s) above or two or more of non-co-polymeric polycarbonate polyols above with a molar excess of isocyanate to form an isocyanate adduct; and then reacting the resultant isocyanate adduct with the hydroxyalkyl acrylate or hydroxyalkyl methacrylate above.

In the present specification, a gel permeation chromatography (GPC) chart may be used in order to verify a chain extension of a resulted urethane acrylated polymer via values of weight average molecular weight (Mw). The GPC charts are generally estimated by the value in terms of polystyrene.

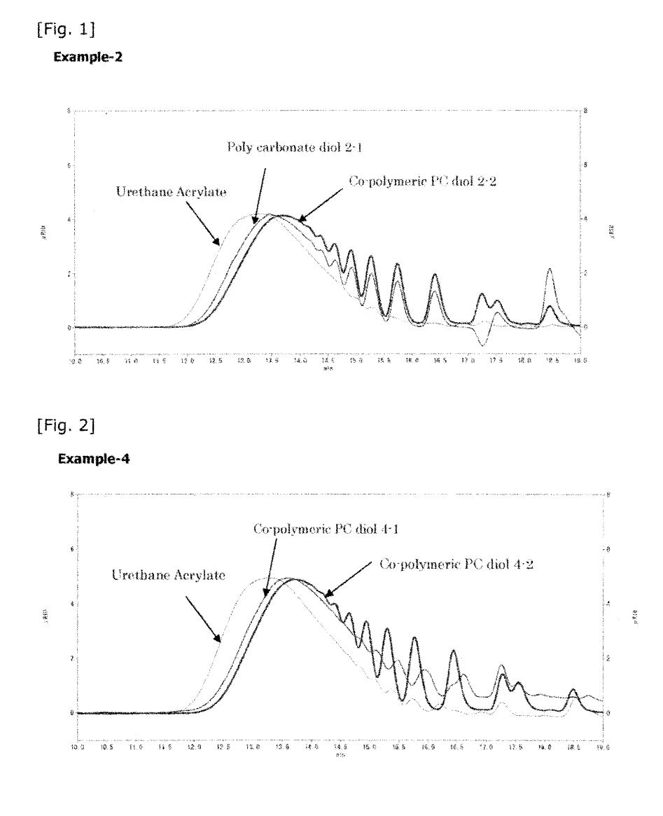

For instance, the present polymers may be verified by following a shift in time elution representing the increase of molecular weight step after step up to the final polymer, as shown in FIGS. 1 to 4. The figures illustrate that the peaks were shifted to heavy molecular weight (left to right) step by step by additions of ingredients/components. Further details will be described below.

The present polymer may be cured by a radiation such as a light emitted from a UV lamp or a light emitting diode (LED) lamp, electron beam (EB), and laser beam. In another embodiment, the present polymer may be a peroxide-curable (P-curable) composition or a dual (radiation- and P-) curable composition. In still other embodiment, the present polymer may be a M-curable composition which may be cured via the Michael addition with polyamines, in the case that a hydroxyalkyl acrylate is used as the acrylate.

In an embodiment, the present polymer may work as a coating composition and may be applied onto a substrate and then cured to form a coating. The substrate may include, but not limited to, a plastic such as polyvinyl chloride, polycarbonate, polystyrene and polyester. The coating composition may include, but not limited to, paints, inks, adhesives, or gel coats.

In an embodiment, the present polymer may be a molding composition or a composite material composition, or a composition for 3D articles to be subjected under successive layer coating and curing procedures. The curable composition may be cured by the known means such as UV or LED light and electron or laser beam, as shown above, with reduced shrinkage. The 3D articles may be effectively output from any kinds of 3D printers using some photo-emitting devices (e.g., photo-molding type, stereo lithography type, ink-jet type, selective laser sintering type, and projection type), since a curable raw material, including the present polymer, is less shrank during the molding process and exerts good formability. Without wishing to be bound by any theory, it is believed that the combined, well-balanced physical/chemical prosperities of the present polymer would be convenient for 3D printing.

### EXAMPLES

The following non-limiting examples illustrate a few embodiments of the invention.

### Example 1: Preparation of Aliphatic Polycarbonate Urethane Acrylate

27.0 grams of isophorone diisocyanate, 0.1 gram of 4-methoxyphenol, 0.1 gram of dibutyltin dilaurate were charged into a 1000 mL reactor. 14.0 grams of 2-hydroxyethyl acrylate (Mn: 116) was added drop wise with dry air sparge and reacted for 2 hours at 50 to 60° C. It was then heated to 75° C. and 33.0 grams of polycarbonate diol (PC1-1: polyhexanediol carbonate; Mn: 1000; OH value: 110±10 KOH mg/g) were added in the mixture. After the completion of PC1-1 addition, and 25.0 grams of polycarbonate diol (c-PC1-2: caprolactone co-polymerized polyhexanediol carbonate; Mn: 1000; OH value: 110±10 KOH mg/g) were added in the mixture. The final resin was obtained as clear viscous material with viscosity of 50000 cps at 60° C.

### Example 2: Preparation of Aliphatic Polycarbonate Urethane Acrylate

22.0 grams of isophorone diisocyanate, 0.1 gram of 4-methoxyphenol, 0.1 gram of dibutyltin dilaurate were charged into a 1000 mL reactor. 34.0 grams of caprolactone-modified hydroxyhexyl acrylate (Mn: 344; OH value: 165±10 KOH mg/g) was added drop wise with dry air sparge and reacted for 2 hours at 50 to 60° C. It was then heated to 75° C. and 21.0 grams of polycarbonate diol (PC2-1: polyhexanediol carbonate; Mn: 1000; OH value: 110±10 KOH mg/g) were added in the mixture. After the completion of PC2-1 addition, and 23.0 grams of polycarbonate diol (c-PC2-2: co-polymerized carbonate of polycyclohexane dimethanol and polyhexane diol; Mn 900; OH value: 125±10 KOH mg/g) were added in the mixture. The final resin was obtained as clear viscous material with viscosity of 30000 cps at 60° C.

The intermediate or final resin was subjected to gel permeation chromatography (GPC) for three times, the value in terms of polystyrene. The measurement conditions of GPC are given below.

Model: Hitachi High-Technologies Corporation made by high-performance liquid chromatogram Lachrom Elite

Column: KF-804 and Co. SHODEX KF-801, KF-803 Showa Denko

Eluent: THF

Flow rate: 0.45 mL/min

Detection: RI (differential refractometer)

The resulted GPC chart is shown in FIG. 1. The addition of the excess diisocyanate to the acrylate produced the curve labeled with “Urethane Acrylate”, having the left most broad peak. The addition of “PC2-1” made the curve labeled with “Poly carbonate diol 2-1” which was shifted toward right direction on the time axis; the change means that molecular weight was increased by the reaction. The small sharp peaks correspond to chain extensions. Then the addition of “c-PC2-2” produced the final polymer which correspond to the last curve labeled with “Co-polymeric PC diol 2-2” which was further shifted to heavy molecular weight. Comparing the curves, the increase in molecular weight in the GPC diagram shall confirm the co-reaction of all components with a significant chain extension.

### Example 3: Preparation of Aliphatic Polycarbonate Urethane Acrylate

31.0 grams of isophorone diisocyanate, 0.1 gram of 4-methoxyphenol, 0.1 gram of dibutyltin dilaurate were charged into a 1000 mL reactor. 27.0 grams of 4-hydroxybutyl acrylate was added drop wise with dry air sparge and reacted for 2 hours at 50 to 60° C. It was then heated to 75° C. and 42.0 grams of polycarbonate diol (c-PC3: co-polymerized carbonate of polycyclohexane dimethanol and polyhexane diol; Mn: 900; OH value: 125±10 KOH mg/g) were added in the mixture and reacted for 2 hours at 90° C. The final resin was obtained as clear viscous material with viscosity of 23000 cps at 60° C.

### Example 4: Preparation of Aliphatic Polycarbonate Urethane Acrylate

18.0 grams of toluene diisocyanate, 0.1 gram of 4-methoxyphenol, 0.1 gram of dibutyltin dilaurate were charged into a 1000 mL reactor. 36.0 grams of caprolactone-modified hydroxyhexyl acrylate was added drop wise with dry air sparge and reacted for 2 hours at 50 to 60° C. It was then heated to 75° C. and 22.0 grams of polycarbonate diol (c-PC4-1: caprolactone co-polymerized polyhexanediol carbonate; Mn: 1000; OH value: 110±10 KOH mg/g) were added in the mixture. After the completion of c-PC4-1 addition, and 23.5 grams of polycarbonate diol (c-PC4-2: co-polymerized carbonate of polycyclohexane dimethanol and polyhexane diol; Mn: 900; OH value: 125±10 KOH mg/g) were added in the mixture. The final resin was obtained as clear viscous material with viscosity of 30000 cps at 60° C.

The intermediate/final resin was subjected to the GPC measurement for three times, as the same as Example 2 above. The resulted GPC chart is shown in FIG. 2. FIG. 2 has similar characteristics to FIG. 1, and also confirms the increase of molecular weight, and the co-reaction of all components with a significant chain extension was sufficiently carried out.

### Example 5: Preparation of Aliphatic Polycarbonate Urethane Acrylate

24.5 grams of dicyclohexylmethane 4,4-diisocyanate, 0.1 gram of 4-methoxyphenol, 0.1 gram of dibutyltin dilaurate were charged into a 1000 mL reactor. 32.0 grams of caprolactone-modified hydroxyhexyl acrylate (Mn: 344; OH value: 165±10 KOH mg/g) was added drop wise with dry air sparge and reacted for 2 hours at 50 to 60° C. It was then heated to 75° C. and 43.0 grams of polycarbonate diol (c-PC5: caprolactone co-polymerized polyhexanediol carbonate; Mn: 1000; OH value: 110±10 KOH mg/g) were added in the mixture and reacted for 2 hours at 90° C. The final resin was obtained as clear viscous material with viscosity of 60000 cps at 60° C.

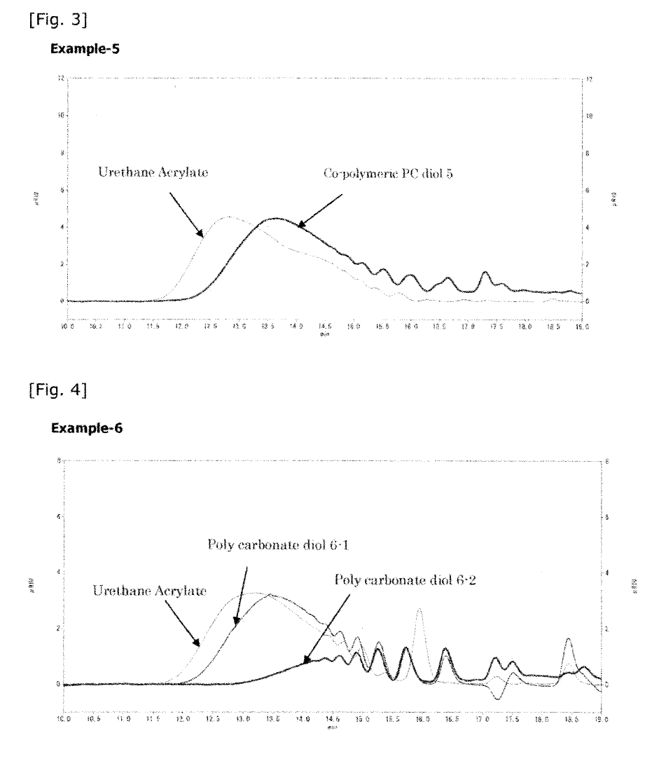

The intermediate/final resin was subjected to the GPC measurement for two times, as the same as Example 2 above. The resulted GPC chart is shown in FIG. 3. This example used one co-polymeric PC diol. The curve labeled with “Co-polymeric PC diol 5” has right-shifted broad peak compared to the former “Urethane Acrylate” curve. The result certainly confirms the increase of molecular weight and significant chain extension.

### Example 6: Preparation of Aliphatic Polycarbonate Urethane Acrylate

33.0 grams of isophorone diisocyanate, 0.1 gram of 4-methoxyphenol, 0.1 gram of dibutyltin dilaurate were charged into a 1000 mL reactor. 16.0 grams of 2-hydroxyethyl acrylate (Mn: 116) was added drop wise with dry air sparge and reacted for 2 hours at 50 to 60° C. It was then heated to 75° C. and 35.0 grams of polycarbonate diol (PC6-1: polyhexanediol carbonate; Mn: 1000; OH value: 110±10 KOH mg/g) were added in the mixture. After the completion of PC6-1 addition, and 17.0 grams of polycarbonate diol (c-PC6-2: polyhexanediol carbonate; Mn: 500; OH value: 224±20 KOH mg/g) were added in the mixture. The final resin was obtained as clear viscous material with viscosity of 25000 cps at 60° C.

The intermediate/final resin was subjected to the GPC measurement for three times, as the same as Example 2 above. The resulted GPC chart is shown in FIG. 4. The addition of the excess diisocyanate to the acrylate produced the curve labeled with “Urethane Acrylate”, having the left most broad peak and some small peaks. The addition of “PC6-1” made the curve labeled with “Poly carbonate diol 6-1” which was shifted toward right direction on the time axis; the change means that molecular weight was increased by the reaction. Further small sharp peaks appeared and they would correspond to chain extensions. Then the addition of “c-PC6-2” produced the final polymer which correspond to the last curve labeled with “Co-polymeric PC diol 6-2” which was further shifted to heavy molecular weight. Comparing the curves, the increase in molecular weight in the GPC diagram shall confirm the co-reaction of all components with a significant chain extension.

### Comparative Examples 1

A conventional urethane acrylate polymer resin was prepared as a polyadditon compound made from a homopolycarbonate diol consisting of 1,6-hexanediol and dimethyl ester, and hydroxyethyl acrylate.

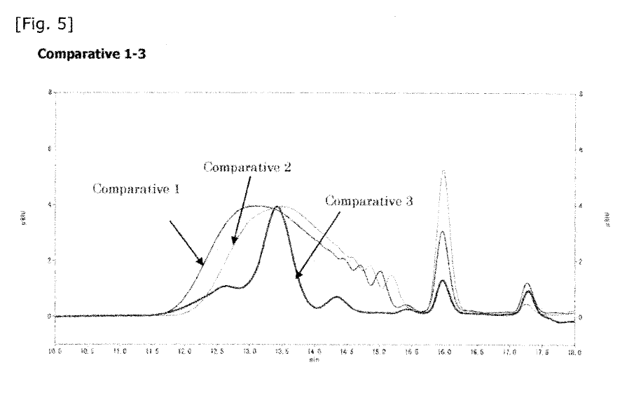

26.0 grams of isophorone diisocyanate, 0.1 gram of 4-methoxyphenol, 0.1 gram of dibutyltin dilaurate were charged into a 1000 mL reactor. 14.0 grams of 2-hydroxyethyl acrylate (Mn: 116) was added drop wise with dry air sparge and reacted for 2 hours at 50 to 60° C. It was then heated to 75° C. and 60.0 grams of homopolycarbonate diol (polyhexanediol carbonate; Mn: 1000; OH value: 110±10 KOH mg/g) were added in the mixture and reacted for 2 hours at 90° C. The conventional final resin was subjected to the GPC measurement as the same as Example 2 above. The resulted GPC chart is shown in FIG. 5.

### Comparative Examples 2

A conventional polymer resin, containing no PC diol moiety, was prepared as a polyadditon compound made from a diethylene glycol, isophorone diisocyanate, and caprolactone acrylate.

36.0 grams of isophorone diisocyanate, 0.1 gram of 4-methoxyphenol, 0.1 gram of dibutyltin dilaurate were charged into a 1000 mL reactor. 56.0 grams of caprolactone-modified hydroxyhexyl acrylate (Mn: 344; OH value: 165±10 KOH mg/g) was added drop wise with dry air sparge and reacted for 2 hours at 50 to 60° C. It was then heated to 75° C. and 9.0 grams of diethylene glycol (Molecular weight: 106.12) were added in the mixture and reacted for 2 hours at 90° C. The conventional final resin was subjected to the GPC measurement as the same as Example 2 above. The resulted GPC chart is shown in FIG. 5.

### Comparative Examples 3: Preparation of Conventional Aliphatic Polyether Urethane Acrylate

22.0 grams of isophorone diisocyanate, 0.1 gram of 4-methoxyphenol, 0.1 gram of dibutyltin dilaurate were charged into a 1000 mL reactor. 11.5 grams of 2-hydroxyethyl acrylate (Mn: 116) was added drop wise with dry air sparge and reacted for 2 hours at 50 to 60° C. It was then heated to 75° C. and 6.0 grams of polyether polyol (PolyoxyPropyleneTrimethyrolPropanether; Mn: 400) were added in the mixture. After the completion of polyol addition and 60.0 grams of polyether polyol (PolyoxyPropyleneGlycol; Mn: 4000) were added in the mixture. The final resin was obtained as clear viscous material with viscosity of 2500 cps at 60° C. The final resin was subjected to the GPC measurement as the same as Example 2 above. The resulted GPC chart is shown in FIG. 5. The curves in FIG. 5 illustrate that the comparative examples had similar Mw to the present polymers; but the comparative examples had different properties from the present polymers as shown below.

The following table illustrates a summary of components used in Examples 1 to 6.

TABLE 1

| | Isocyanate | Acrylate | Polyol(s) | |
|---|---|---|---|---|
| Example 1 | IPDI | C2 alkyl | PC diol 1-1 | Co-polymeric |
| | | | | PC diol 1-2 |
| Example 2 | IPDI | C6 + C2 | PC diol 2-1 | Co-polymeric |
| | | alkyl ester | | PC diol 2-2 |
| Example 3 | IPDI | C4 alkyl | Co-polymeric | |
| | | | PC diol 3 | |
| Example 4 | TDI | C6 + C2 | Co-polymeric | Co-polymeric |
| | | alkyl ester | PC diol 4-1 | PC diol 4-2 |
| Example 5 | MDI | C6 + C2 | Co-polymeric | |
| | | alkyl ester | PC diol 5 | |
| Example 6 | IPDI | C2 alkyl | PC diol 6-1 | PC diol 6-2 |

### Example 7: Polycarbonate Based Acrylate Oligomers in UV Radiation Curing

The prepared resins above were tested in UV radiation cure. The neat resins were blended With 3% liquid photo initiator (Irgacure 184, manufactured by BASF). The final blends were coated on 100 micron PET film #10 to #50 application wire rod. The coated substrates were then cured on a UV curing unit equipped With a 300 mJ/cm² Hg lamp at a speed of 15 mpm. The cured coatings were tested for elongation, tensile stress, pencil hardness tests. The elongation and tensile strength tests were according to JIS K 7161 and JIS K 7127. The pencil hardness test was according to JIS K5600-5-4. The results are shown in Table 2 below.

TABLE 2

| | Elongation | Tensile Stress | Pencil |
|---|---|---|---|
| | [%] | [psi] | Hardness |
| Example 1 | 196 | 3582 | HB |
| Example 2 | 346 | 4186 | F |
| Example 3 | 83 | 5285 | H |
| Example 4 | 273 | 2419 | F |
| Example 5 | 209 | 1926 | HB |
| Example 6 | 110 | 1500 | HB |
| comp. ex. 1 | 148 | 2475 | B |
| comp. ex. 2 | 81 | 3740 | HB |
| comp. ex. 3 | 141 | 966 | 3B |

1: Lot of Scratch
2: Little scratch
3: Almost no scratch
4: No scratch

### Example 8: Abrasion Resistance Test

The coated surface prepared by Example 7 was subjected to 20 double rubs with #0000 steel wool at constant load (500 grams) and velocity, after which the sample has been visually inspected for scratches in the coating and rated based on the condition of the scratches.

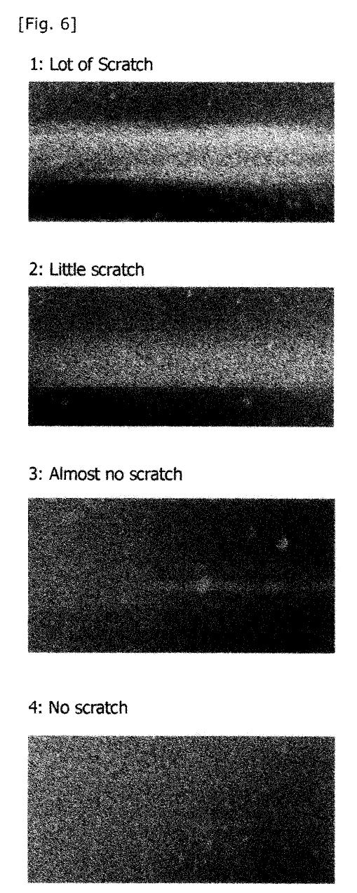

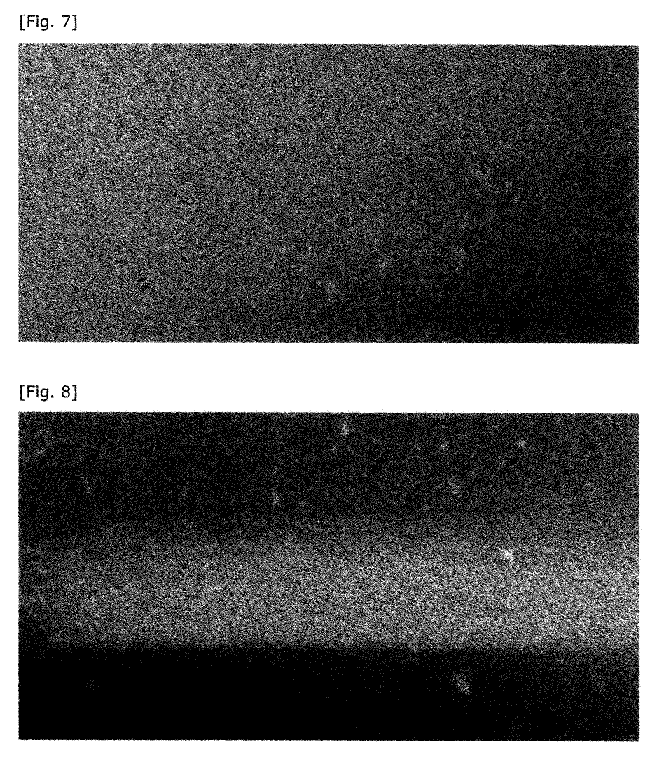

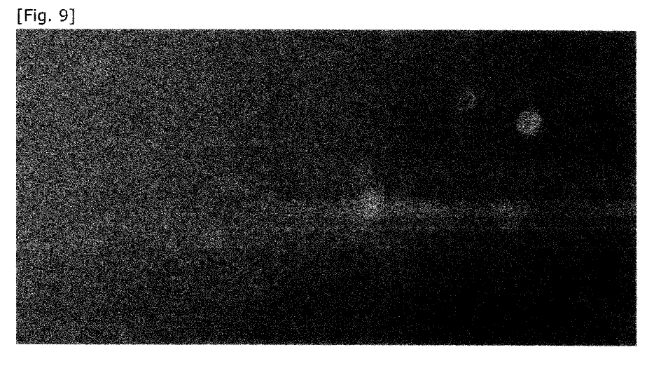

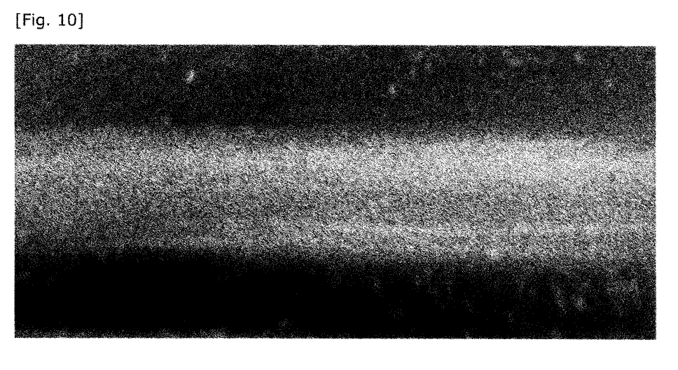

The results were evaluated in four levels, namely “Lot of Scratch”, “Little Scratch”, “Almost No Scratch”, and “No Scratch”. FIG. 6 shows all of the four levels to easily compare with each other. The results are also illustrated in the photographs as FIGS. 7 to 10 that were taken from Example 2, Example 3, Example 5, and comparative example 1, respectively.

### Example 9: Self-Healing Test

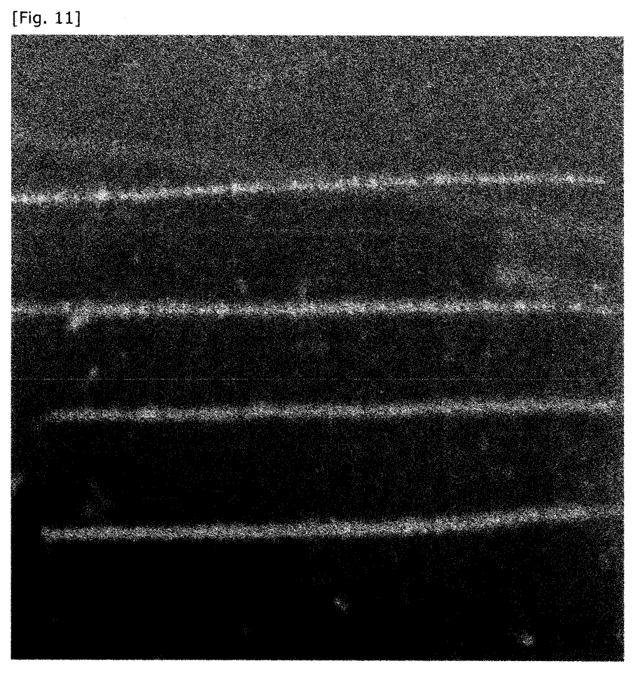

The coated surface prepared by Example 7 was subjected to 10 double rubs with copper brush, after which the sample has been visually inspected after 1 minute to check the restoration level of the scratches in the coating and rated based on the condition of the scratches restored. The initial condition of the scratched surface is shown in FIG. 11.

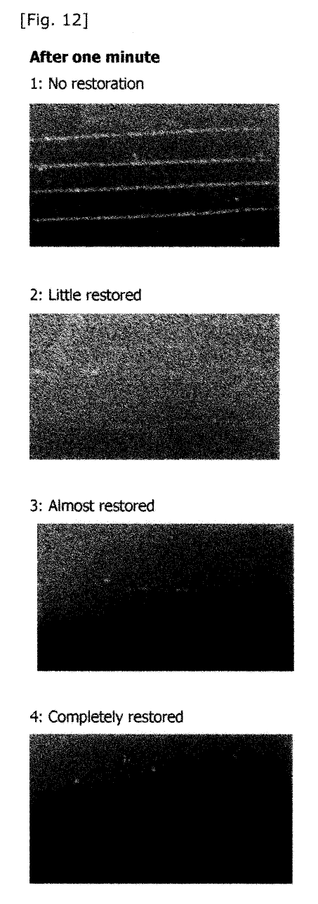

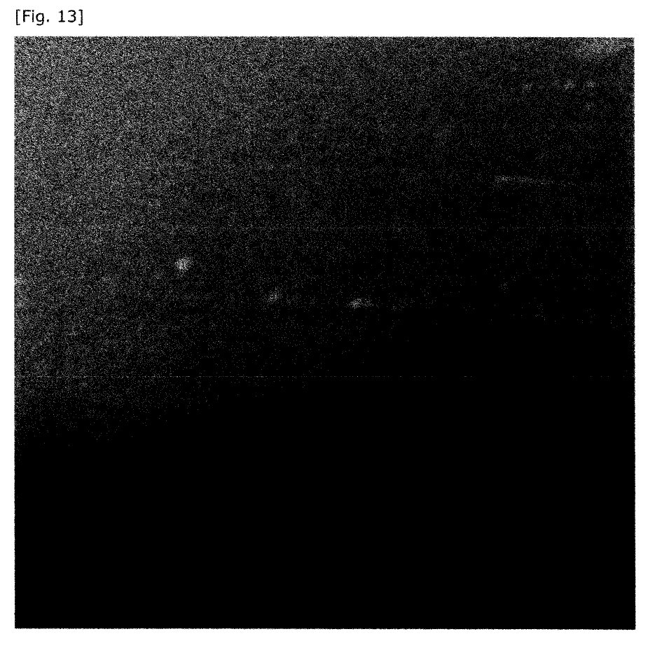

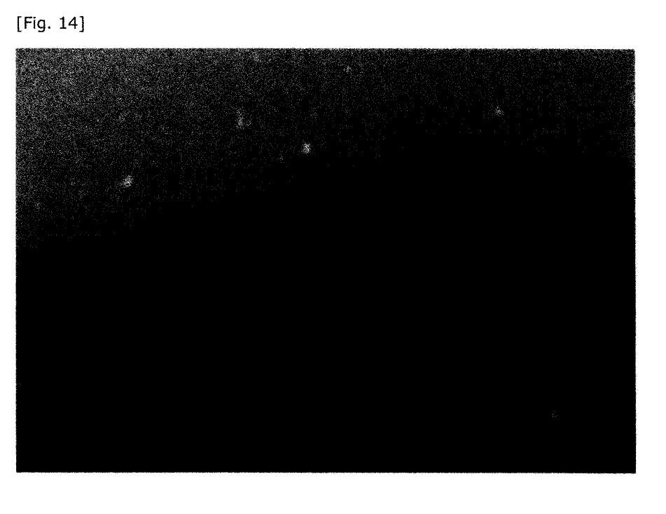

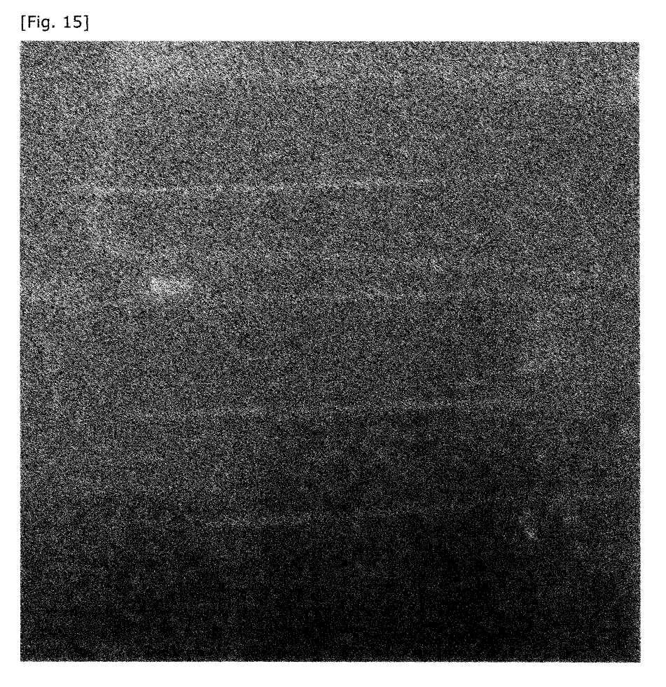

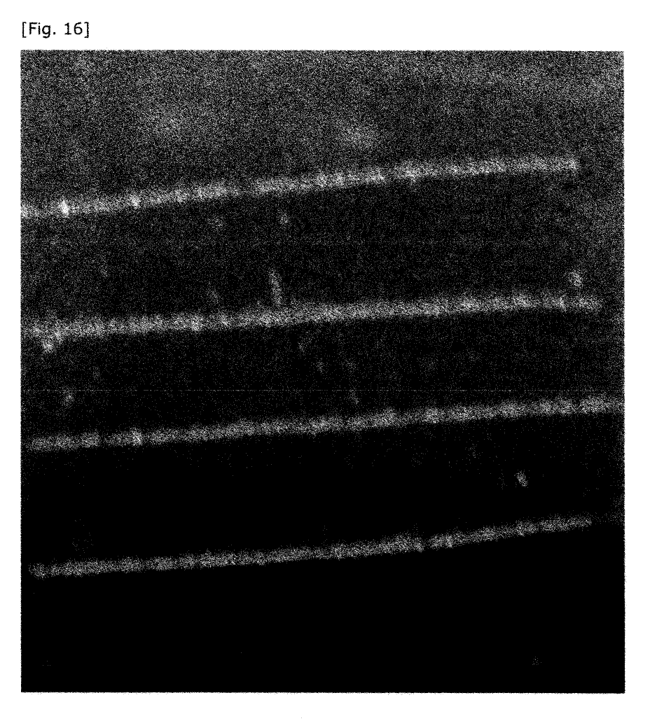

The results were evaluated in four levels, namely “No Restoration”, “Little Restored”, “Almost Restored”, and “Completely Restored”, based on the initial condition. FIG. 12 shows all of the four levels to easily compare with each other. The results are also illustrated in the photographs as FIGS. 13 to 16 that were taken from Example 1, Example 4, Example 5, and comparative example 3, respectively.

The results of Examples 8 and 9 are summarized in Table 3 below.

TABLE 3

| | Abrasion Resistance | Self healing properties |
|---|---|---|
| Example 1 | 3 | 3 |
| Example 2 | 4 | 4 |
| Example 3 | 2 | 1 |
| Example 4 | 4 | 4 |
| Example 5 | 3 | 2 |
| Example 6 | 2 | 1 |
| comp. ex. 1 | 1 | 1 |
| comp. ex. 2 | 1 | 1 |
| comp. ex. 3 | 1 | 1 |

1: No restoration
2: Little restored
3: Almost restored
4: Completely restored

As shown in the above results, the present polymers are superior in elongation, tensile stress, and pencil hardness, and also have better abrasion resistance and self-healing properties. The properties are well balanced, and the present polymers are quite useful in the industries.

1. A urethane-acrylated polymer comprising a reaction product of the ingredients including:
[i] a first homopolymeric or co-polymeric polycarbonate polyol;
[ii] an organic polyisocyanate; and
[iii] a hydroxy-functional acrylate or methacrylate of general formula
(Acr)ᵣ(A)-OH
where Acr is an acrylate or methacrylate group, A is the residue of a polyol A(OH)_{y+1} with y being an integer ranging from 1 to 5, A being selected from C₂ to C₁₈ alkyl and C₂ to C₁₈ alkyl that may be modified by at least one unit of a cyclic ester or A is C₂ to C₁₈ alkoxylated alkyl, with alkoxy being in C₂ to C₄, the acrylate or methacrylate having a functionality in acrylate or methacrylate groups ranging from 1 to 5,
and with the proviso that when the first polycarbonate polyol is not co-polymeric, then the ingredients further include:
[iv] a second homopolymeric or co-polymeric polycarbonate polyol, different from the first one according to i) and
wherein the polycarbonate polyol(s) is/are linked to the polyisocyanate via a urethane linkage, and
wherein the polyisocyanate is linked to the alkyl moiety of the hydroxyalkyl acrylate or hydroxyalkyl methacrylate via a urethane linkage.

2. The polymer of claim 1, wherein said polycarbonate polyol(s) according to i) and if present iv), is (are) diol(s), and wherein said polymer comprises a product having formula (I):
(Acr)_{y}(A)(Q)(PC)[(Q)(PC)]ₓ(Q)(A)(Acr)_{y} (I)
wherein
(Acr)_{y}(A) is the residue of the hydroxy-functional acrylate or methacrylate;
Q is the residue of the organic diisocyanate connected with A and PC via a urethane linkage;
x is an integer from 1 to 20;
PC is the residue of the said polycarbonate diol(s) according to i) and of if present iv), and with said PC representing accordingly homopolymeric or/and co-polymeric structure.

3. The polymer of claim 1, wherein two homopolymeric polycarbonate polyols are present as defined according to i) and iv) which are both homopolymeric polycarbonate diols having the same general formula (II) but with different R:
HO(ROCOO)ₙROH (II)
wherein
R is a residue of diol independently selected from C₁ to C₁₈ alkylene, C₆ to C₁₈ cycloalkylene or cycloalkylalkylene, and C₆ to C₁₈ aromatic groups, or their derivatives and
n is an integer from 1 to 10,000

4. The polymer of claim 1, wherein the number average molecular weight Mn of the first or second polycarbonate polyol is 500 to 3,000.

5. The polymer of claim 1, wherein both the first and second polycarbonate polyols are co-polymeric.

6. The polymer of claim 1, wherein one of the first and second polycarbonate polyols is homopolymeric and the other is co-polymeric.

7. The polymer of claim 5, wherein the co-polymeric polycarbonate polyol(s) include(s) C₂ to C₈ alkylene diol moiety, C₆ to C₈ cycloalkylene diol moiety, or combinations thereof.

8. The polymer of claim 5, wherein the co-polymeric polycarbonate polyol(s) is/are derived from the co-polymerization of a polycarbonate diol with a cyclic ester.

9. The polymer of claim 1, wherein the first and/or second polycarbonate polyol(s) is/are aliphatic.

10. The polymer of claim 1, wherein the first and/or second polycarbonate polyol(s) is/are derived from ethoxylated bisphenol A, cyclic aliphatic alkylene diol, alkylene diol, or ring-opened diol of caprolactone.

11. The polymer of claim 1, wherein the organic polyisocyanate is selected from the group consisting of aliphatic, cycloaliphatic and aromatic diisocyanates and has 6 to 18 carbon atoms.

12. The polymer of claim 1, wherein the hydroxy-functional acrylate or methacrylate according to iii) is selected from C₂ to C₁₈ alkyl modified by at least one unit of a cyclic ester which is caprolactone.

13. A process for preparing the urethane acrylated polymer of claim 1, comprising the steps of:
a) reacting one of said hydroxy-functional acrylate or methacrylate according to iii) and the first polycarbonate polyol according to i) with a molar excess of said isocyanate according to ii) by progressive addition of said acrylate or methacrylate according to iii) or the first polycarbonate polyol i) in said isocyanate ii), in the presence of an urethane reaction catalyst and of a polymerization inhibitor, to form an isocyanate adduct; and then
b) reacting the resultant isocyanate adduct of step a) with the other of iii) and i) by progressive addition of the other of iii) and i) into said adduct to the resulting reactive mixture to obtain the said polymer,
wherein if the second polycarbonate polyol according to iv) is used, the progressive addition of the first polycarbonate polyol according to i) is followed by a successive step with said polycarbonate polyol according to iv) by progressive addition of iv).

14. A curable composition comprising at least one polymer as defined according to claim 1.

15. The composition of claim 14, wherein the composition is selected from the group consisting of:
a radiation-curable composition, particularly UV, LED, EB, or laser curable composition,
a peroxide-curable composition,
a dual (radiation- and peroxide-) curable composition, and
in the case the ingredient iii) is a hydroxyalkyl acrylate, a composition curable via Michael addition with polyamines.

16. The composition of claim 14, wherein the composition is a coating composition, selected from the group consisting of paints, inks, adhesives, and gel coats.

17. (canceled)

18. A cured product, wherein the cured product results from the curing of at least one polymer as defined in claim 1.

19. The product of claim 18, wherein the product is selected from the group consisting of: coatings, molded parts or articles, composite materials, and 3D articles prepared by successive layer coating and curing procedures.

20. An article comprising the cured product according to claim 18.

21. The polymer of claim 1, wherein A is selected from C₂ to C₁₈ alkyl and C₂ to C₁₈ alkyl which is modified by at least one unit of a cyclic ester which is caprolactone.

22. The polymer of claim 1, wherein the number average molecular weight Mn of the first or second polycarbonate polyol is 500 to 2,000.

23. The process of claim 13, wherein both reaction steps a) and b) are carried out in bulk and in the absence of any solvent.

24. The composition of claim 14, wherein the curable composition is selected from the group consisting of a molding composition, a composite material composition, and a composition for 3D articles to be subjected under successive layer coating and curing procedures
